(19) United States
(12) Patent Application Publication
(10) Pub. No.: US 2011/0148267 A1
(43) Pub. Date: Jun. 23, 2011

(54) SLUMPED GLASS SPILL PROOF SHELF FOR AN APPLIANCE AND METHOD OF MANUFACTURING A SHELF

(76) Inventors: Aaron Matthew McDANIEL, Louisville, KY (US); Jonathan Nash, LaGrange, KY (US); Cory J. Tafoya, Louisville, KY (US); Ragavendra Prabhakar, Chennai (IN); Sai Krishna Kunchala, Kadapa (IN)

(21) Appl. No.: 12/641,462

(22) Filed: Dec. 18, 2009

(51) Int. Cl. F25D 23/00; C03B 19/00; A47F 5/00; F16M 13/00; F25D 25/02

(52) U.S. Cl. 312/404; 65/66; 211/134; 248/250; 248/201

(57) ABSTRACT

A spill proof shelf, a refrigerator using the same and a method of manufacturing a shelf are disclosed. The spill proof shelf has a sheet defining a main plane. The sheet includes a plurality of raised surfaces that extend from a top surface to define a spill proof area on the top surface. At least one of the raised surfaces has an end. The shelf also has a lip. The lip has a front edge and extends outward from the end of the at least one of the raised surfaces with the front edge being in a plane different from the main plane.

### CROSS-REFERENCE TO RELATED APPLICATIONS

The present application relates to the application entitled SHELF FOR AN APPLIANCE, attorney docket no. 239275, filed ______.

### BACKGROUND OF THE INVENTION

The present disclosure relates generally to shelf assemblies for refrigerators and to a slumped, spill proof, tempered glass refrigerator shelf. Even more particularly, the present disclosure relates to a shelf that is transparent, that is easier to clean and that includes a front lip that slumps away from a raised surface of the shelf to act as a reinforcing rib. The shelf also has a bracket that supports the shelf in at least two locations.

A refrigerator typically includes a number of shelves for the storage of food and beverage containers of a variety of shapes and sizes. As the containers are retrieved, returned and rearranged on the shelves, occasional leaks and spills of food and liquid may occur. Extensive cleanup efforts are required since the liquid will commonly flow down through the compartment, from shelf to a lower shelf. Therefore, it is desirable to provide containment implements for the refrigerator to limit the area of such a spill.

A spill proof shelf of a refrigerator includes a frame, a glass pane supported by the frame, and may include one or more support brackets mating with the cant tracks of the refrigerator. Generally, a plastic material will border the glass pane. The plastic border will sit on ribs molded in to the appliance liner in appliances that do not incorporate cant tracks. For units with cant tracks, the plastic border supports the glass pane and interfaces with the brackets in a snap fitting arrangement. Although useful, as the shelf can be easily and conveniently disassembled to replace the glass pane in case the glass pane breaks, generally there is a problem because the interface between the plastic border and the glass pane can be very difficult to clean. Fluids and food matter can aggregate in the intersection between the plastic border and the glass pane. This aggregation can lead to grime forming in the intersection. A longer and more difficult scrubbing effort may be required to clean the desired area since the intersection between the plastic border, the glass pane and the brackets is small in size.

Additionally, from an aesthetic perspective, only the glass central pane is translucent while the plastic border is not translucent. The plastic border surrounds each glass pane in the shelf and obstructs light. Therefore, the refrigeration compartment can be aesthetically displeasing to certain customers to see the plastic border that surrounds the glass pane. Customers would prefer to have a shelf without any plastic border that does not block the light but that is translucent. Customers also want a strong and sturdy shelf that does not give up any strength and that includes the same structural integrity as the glass pane with the plastic border. Additionally, a glass pane with a plastic border requires a number of parts for manufacture and installation. The number of parts required for assembly requires a certain predetermined installation time and manufacturing cost. Such costs potentially can increase the costs of the appliance.

Furthermore, the glass pane of the shelf often is a rectangular sheet that has a predetermined size and a predetermined thickness. The rectangular glass pane is thick, surrounded by the plastic border and is supported on one or more lateral sides of the pane. However, this predetermined pane thickness and geometry may lead to a stiff and stressed shelf configuration, when loaded. If loaded beyond capacity, the shelf may crack or be subjected to a predetermined fatigue stress. A shelf geometry having a reinforced and improved geometry would be advantageous that increases strength, reduces bending stiffness and provides for less stress along at least one parameter of the shelf.

### BRIEF DESCRIPTION OF THE INVENTION

As described herein, the various exemplary embodiments of the present invention overcome one or more of the above or other disadvantages known in the art.

One aspect of the present disclosure relates to a shelf assembly. The shelf assembly has a sheet defining a main plane. The sheet includes a plurality of raised surfaces that extend from a top surface to define a spill proof area on the top surface. At least one of the raised surfaces has an end. The sheet also has a lip having a from edge and extending outward from the end of the at least one of the raised surfaces with the front edge being in a plane different from the main plane.

Another aspect of the present disclosure relates to a method of manufacturing a shelf. The method provides a moldable material and provides a mold. The mold includes a first mold surface defining a main plane. The mold also has a plurality of raised surfaces. The raised surfaces extend from the first mold surface to define a spill proof area on the first mold surface. The mold also has a second mold surface. The second mold surface is connected to at least one of the plurality of raised surfaces of the first mold surface. The second mold surface extends outward from the raised surface of the first mold surface. The second mold surface has an end that is in a plane, which is different from the main plane. The moldable material is placed on the mold and then is placed in a kiln and the moldable material is heated to a transition temperature to shape the moldable material to the mold. The moldable material is removed from the mold and the removed from the kiln and cooled to form the shelf. The shelf is separated from the mold.

Another aspect of the present disclosure relates to a refrigerator. The refrigerator has a storing compartment and a shelf disposed in the storing compartment. The shelf has a tempered glass sheet. The tempered glass sheet defines a main plane. Raised surfaces extend upward from the main plane to define a spill proof area on the tempered glass sheet. At least one of the raised surfaces has an end. The tempered glass sheet further has a lip with a front edge. The lip extends outward from the end of the at least one raised surface with the front edge of the lip being in a plane different from the main plane. The tempered glass sheet, the plurality of raised surfaces and the lip form a unitary member.

These and other aspects and advantages of the present disclosure will become apparent from the following detailed description considered in conjunction with the accompanying drawings. It is to be understood, however, that the drawings are designed solely for purposes of illustration and not as a definition of the limits of the disclosure, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a perspective view of a tempered glass refrigerator shelf according to an exemplary embodiment of the present disclosure.

FIG. 2 is a top view of the tempered glass shelf having a downwardly sloping surface as shown in FIG. 1.

FIGS. 3-6 show views of another embodiment of the tempered glass refrigerator shelf having a rear cut-out portion.

FIG. 7 shows a method of manufacturing the tempered glass refrigerator shelf of FIGS. 1 and 2 showing a side view of a sheet of a moldable material.

FIG. 8 shows the sheet of FIG. 7 introduced with a mold according to the present disclosure.

FIG. 9 shows the sheet heated and slumped on the mold to mold the tempered shelf of the present disclosure.

FIG. 10 shows a completed refrigeration shelf having a downwardly sloping front side or lip that acts as a reinforcing rib and that has an end that is in a different plane and that extends below the bottom surface.

FIGS. 11-13 show a bracket having a bracket lip to hold the glass shelf and to prevent rotation and adhesive bond separation.

FIGS. 14-17 show a first and a second stop member connected to the glass shelf.

FIG. 18 shows the tempered glass shelf mounted in a refrigeration cabinet.

FIG. 19 shows an enlarged view of the bracket lip of FIG. 11.

### DETAILED DESCRIPTION OF THE EXEMPLARY EMBODIMENTS OF THE INVENTION

It is contemplated that the teaching of the description set forth below is applicable to all types of refrigeration appliances, including but not limited to household refrigerators. The present disclosure is therefore not intended to be limited to any particular refrigeration apparatus or configuration described in the exemplary embodiments of the present disclosure. It should be appreciated that the present disclosure may also be applicable to other types of appliances including stove tops, freezers, or any other type of appliance using shelves known in the art.

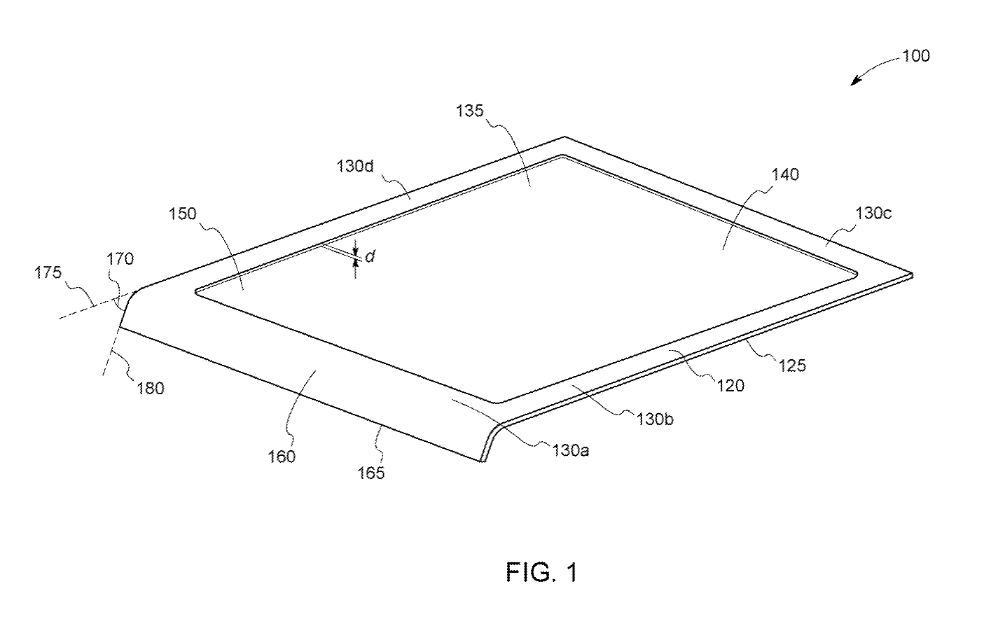

FIG. 1 illustrates a front perspective view of a slumped tempered glass refrigerator shelf 100 according to an exemplary embodiment of the present disclosure. The shelf 100 is preferably molded in a unitary manner from one component or one molded material (a rectangular glass sheet as discussed herein, for example) to be translucent and strong. The shelf 100 includes two sections or features that are molded into the shelf 100. The shelf 100 includes a molded frame component 120 and a plate component 140 integral to the frame component 120. The frame component 120 surrounds the plate-component 140 to form a spill proof volume as discussed herein.

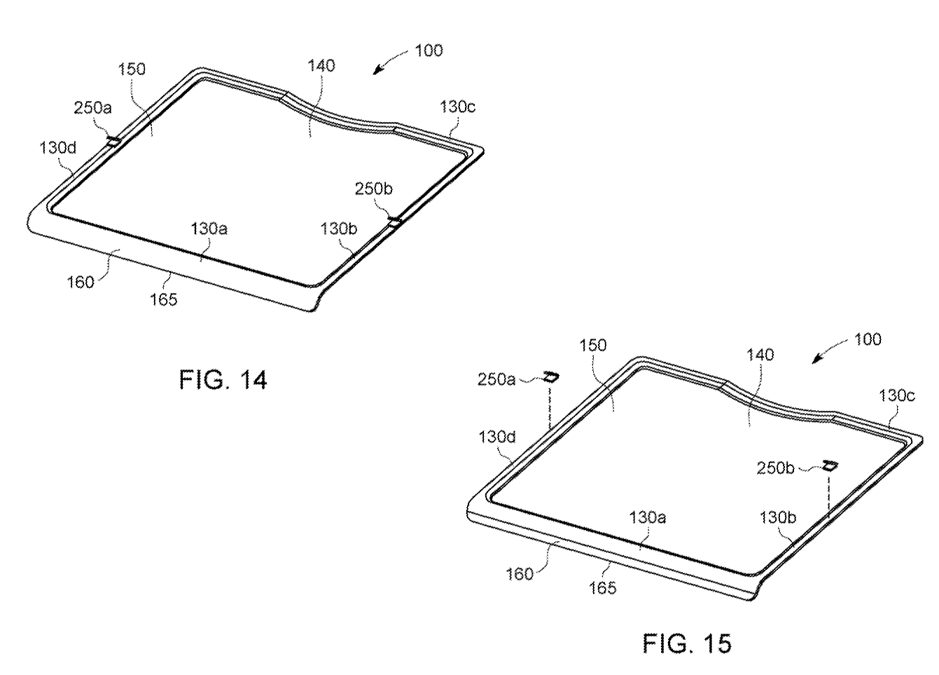

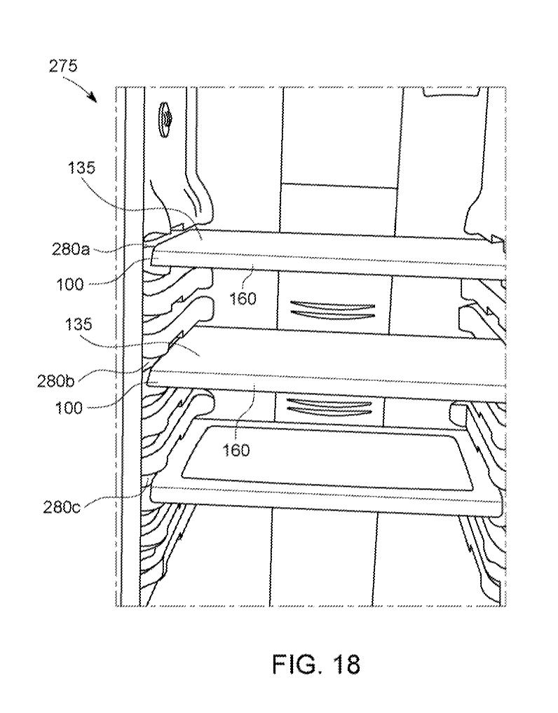

The shelf 100 also includes a pair of support brackets 230, 235 (shown in FIGS. 11-13) preferably connected to a bottom surface 125 of the frame component 120. Each of the brackets 230, 235 supports the shelf 100 in at least two different locations. Brackets 230, 235 are adhered to shelf 100 and also grip the shelf 100 by bracket lips 240 and 242 as discussed herein. Bracket lips 240 and 242 prevent the shelf 100 from rotating relative to the brackets 230, 235. The shelf 100 is provided in a storage compartment of a refrigerator 275, for holding food or beverage containers as shown in FIG. 18. The compartment can be a refrigeration compartment, a freezer compartment, a chiller compartment, or can be used in connection with a different appliance, for example, a beverage center. Various appliance configurations are possible and within the scope of the present disclosure.

The frame component 120 and the plate component 140 are one piece of the same material and are molded together from a single molded material; however, this configuration is not limiting and other methods of manufacturing are contemplated. For example, the shelf 100 can be manufactured from a thermoplastic, a ceramic, or a composite material. Thermoplastic could be used instead of tempered glass. When tempered glass is used, the tempered glass is treated to break safely. Soda-lime float glass is typically used due to cost; however, ceramic glass such as Borosilicate and sintered plate glass could be used to allow the glass to be placed in a dishwasher. Laminated glass could be used, such as used in automotive windshields. These are not generally used in the industry due to high cost.

The shelf 100 is molded from glass and is tempered for strengthening the shelf 100; however, in another embodiment of the present disclosure, the shelf 100 can be fabricated from different materials depending on the appliance that the shelf 100 is intended to be used with and supported within. For a refrigeration appliance or a freezer, the shelf 100 is made from the molded and tempered glass, whereby the shelf is translucent and aesthetically pleasing to allow light to pass through. Less preferably, the shelf 100 can be manufactured from an inexpensive, integrally molded plastic, a homogeneous polymeric or copolymeric plastic material, a talc filled polypropylene, acrylonitrile-butadiene-styrene (ABS), or High Impact Polystyrene (HIPS). Alternatively, the shelf 100 can be manufactured from a ceramic material to allow the shelf 100 to be dishwasher safe. The tempered glass shelf 100 may also be optionally etched with a design or lettering or an aesthetic pattern.

In the shown embodiment, the shelf 100 includes a continuous peripheral frame portion 130a, 130b, 130c and 130d that is unitary and integral to the plate component 140, which is recessed a predetermined distance below the continuous frame portion 130a, 130b, 130c and 130d. The frame component 120 of the shelf 100 is defined by the peripheral frame portion 130a, 130b, 130c and 130d so the peripheral frame portion 130a, 130b, 130c and 130d is raised above the plate component 140 and the plate component 140 is below the peripheral frame portion 130a, 130b, 130c and 130d by a distance d shown in FIG. 1. The peripheral frame portion 120 includes a front frame portion 130a, a rear frame portion 130c, a left frame portion 130d and a right frame portion 130b. The left and right frame portions 130d and 130d connect the front frame portion 130a to the rear frame portion 130c. It should be appreciated that although shown as rectangular in shape, the rectangular shape is not limiting and various other shelf 100 shapes can be used and are within the scope of the present disclosure.

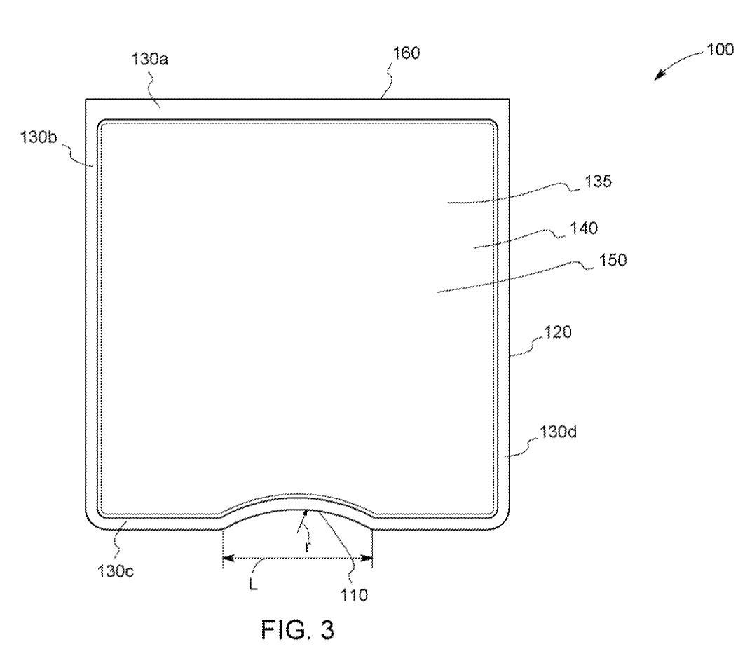

Turning now to FIG. 3, there is shown an alternative embodiment of the shelf 100. The shelf 100 may include a recessed or cut-out portion 110 disposed in the rear of the shelf 100 or on the rear frame portion 130c to accommodate a component of a refrigerator. The cut-out portion 110 has a semi-circular or elliptical shape with a radius r and has a length L that is less than the total length of the rear frame portion 130c.

It should be understood that sometimes the rear frame portion 130c may be generally straight to mate with a rear wall of the refrigeration compartment. However, in another embodiment, a rear conduit or the like may occupy the rear wall of the refrigeration compartment. Therefore, the straight rear frame portion 130c may not fit flush with a rear refrigerator wall having a conduit. Preferably, the cut-out portion 110 mates with a second refrigeration structure, when the shelf 100 is loaded so the shelf 100 fits generally flush with the rear wall of the refrigeration compartment. It should be appreciated that the refrigeration compartment may not include a flat rear wall (or flat side wall) in the rear of the refrigeration compartment and may include a conduit, a light, a fan, a condenser, a coil, a housing, a pipe or similar refrigeration component that may jut out a slight predetermined distance to reduce an overall interior volume of the refrigeration compartment. The cut out portion 110 preferably is sized in a complementary manner to the geometry of the refrigerator or rear wall to accommodate a conduit or the like so the shelf 100 fits generally flush inside the refrigeration compartment. The cut out portion 110 allows the shelf 100 to fit without any substantial gap between the shelf 100 and the refrigerator compartment rear wall so the shelf 100 is aesthetically pleasing to the eye. It should be appreciated that the cut-out portion 110 is optional and is not required and forms no limitations to the present disclosure.

The cut-out portion 110 can be any size known in the art to permit the shelf 100 to fit in a desired refrigeration compartment. Alternatively, the shelf 100 can be made in a non-rectangular shape or can include an extension to provide an additional platform or space to store items. Various shapes are possible and the terms left, right, front and back form no limitation to the present disclosure. The opposite front frame portion 130a and rear frame portion 130c are molded to be generally parallel to each other. The opposite frame portion 130d and frame portion 130b are substantially parallel to each other and perpendicular to the front frame portion 130a and rear frame portion 130c. Accordingly, the peripheral frame portions 130a, 130b, 130c and 130d and the plate component 140 are generally rectangular. The recessed plate component 140, in cooperation with the peripheral frame portion 130a, 130b, 130c and 130d forms a recessed area and a containment region 150, or “spill proof area,”

In the event a carton or food container falls over and leaks and spills a liquid or semi-solid on a top surface 135 of the shelf 100, the spilled solid or liquid material is confined within the containment region 150 and does not leak downwardly underneath the shelf 100. Advantageously, since the frame portion 130d and the plate component 140 are made from the same molded integral member, there is no passageway located between the frame portion 130d and the plate component 140. Likewise, there is no passageway between the frame portion 130b and the plate component 140. Therefore, liquid will not traverse into any opening or passageway causing a difficult clean up and will remain in the containment region ISO. This integral member provides a convenience to the user as no grime will build up between the respective frame portion 130a, 130b, 130c, 130d and the plate component 140 of the shelf 100. This provides for a more sanitary refrigerator shelf 100 as no grime will be trapped in an intersection between any glass pane and plastic border.

Turning now to FIG. 4, there is shown a side view of the shelf 100. The shelf 100, when supported by the brackets (not shown) is capable of supporting food or beverage containers. The plate component 140 is molded to be substantially flat and rectangular for forming the containment region 150; however, this shape forms no limitations to the present disclosure and the plate component 140 and containment region 150 may be manufactured with various geometries and various depths d for containing a volume of liquid. Preferably, when a spill of about 12 ounces occurs on the top surface 135 of the shelf 100, the liquid aggregates in the containment region 150 and does not traverse to the peripheral frame portion 130a, 130b, 130c and 130d. Moreover, the shelf 100 includes a sufficient thickness and strength that the user can wipe up the liquid on the top surface 135 repeatedly and the shelf 100 will remain sturdy and not deform, crack, or otherwise be affected by the force or stress exerted across the containment area 150 to clean the spill. Depth d can be any depth known in the art. Preferably, the thickness of the shelf 100 includes about 4 millimeters with region 150 holding about twelve ounces though this amount may vary depending upon the size, geometry of the shelf 100 and the load capacity of the shelf 100. Various containment region 150 configurations are possible and within the scope of the present disclosure.

The shelf 100 also includes a downwardly sloping end or downward lip 160. The downward sloping lip 160 preferably extends from the front frame portion 130a. Lip 160 extends outward from an end of at least one of the peripheral frame portions 130a, 130b, 130c, 130d and is made as a unitary member with the respective peripheral frame portion 130a. In one non-limiting embodiment, the lip 160 bends in an arcing manner and forms radius 195 relative to the remainder of the shelf 100. Lip 160 traverses at a downward angle 170 from the front frame portion 130 to an end or edge 165 to form the downward lip 160. End 165 is in a different plane than the main plane defined by the top surface 135. Turning now to FIG. 5, there is shown a front view of the shelf 100. The downwardly sloping lip 160 extends along the entire length of the shelf 100 at the front frame portion 130a and is manufactured as an integral member with the front frame portion 130a. The downwardly sloping lip 160 is molded as a feature of the shelf 100 and is made from a tempered and molded glass material.

Referring again to FIG. 4, the downwardly sloping lip 160 preferably extends from the front frame portion 130a at about forty five degrees relative to the top surface 135 of the shelf 100 as shown by a first axis 175 and a second axis 180 angled by the downward angle 170. However, in other embodiments, the angle 170 may vary depending on the dimensions of the glass shelf 100. The angle 170 may be varied and be in a range from ninety degrees to thirty degrees or include other values. Various downwardly angled configurations 170 are possible and within the scope of the present disclosure. The lip 160 acts as a handle and strengthening rib (allowing thinner glass to be used when molding the glass shelf 100). In one embodiment, the glass shelf 100 can be manufactured with a thickness of about 4 millimeters.

The angle 170 of the lip 160 shown in the drawing is about 60 to about 90 degrees, though the angle 170 could be as low as 45 degrees or less. The lower the number the less strength is gained and the less ergonomic the lip 160 becomes. It should be appreciated that the lip 160 does not need to slope downwardly, and the lip 160 could slope in an upward manner, be perpendicular, or be raised rather than drooping. The lip 160 can be curved or straight or a combination curved then straight dependent on styling requirements. The lip 160 is generally up to about 1 inch deep measured from the end 165 to the frame portion 130a. Any deeper and the lip 160 could potentially be in the way during moving objects in and out of the refrigerator or cabinet. In another embodiment, the end 165 of the lip 160 can terminate one inch below the sheet 100. The lip 160 is sized for an ergonomic feel and for strength. For strength purposes of the overall shelf 100, the lip 160 is sized to the glass shelf 100 and is sized based on the load on the shelf 100 along with sufficient safety factor, such as for example, 50 lbs. Therefore, in this embodiment, the lip 160 can have a length in a range of about ½ inch to about 1¼ inches.

Turning now to FIG. 6, there is shown a right sided view of the shelf 100. The downwardly sloping lip 160 may be straight or, alternatively, may include a curvature along a length L of the downwardly sloping lip 160. The downward sloping lip 160 can resemble a so called “water fall” configuration or shape as shown in a side view at FIG. 6. In one embodiment, the end 165 of the downwardly sloping lip 160 may extend about one inch below the bottom surface 125 of the shelf 100, or about one inch below the top surface 135 of the shelf 100. These distances are not limiting and various lengths or distances below the bottom surface 125 or top surface 135 of the shelf 100 are envisioned. This allows the downwardly sloping lip 160 to act as a reinforcing rib for the shelf 100. From the front frame portion 130a to the end 165, the downwardly sloping lip 160 may include a different or non-uniform thickness and can includes a thicker portion and a thinner portion. Various downwardly sloping lip 160 thickness configurations are possible and within the scope of the present disclosure.

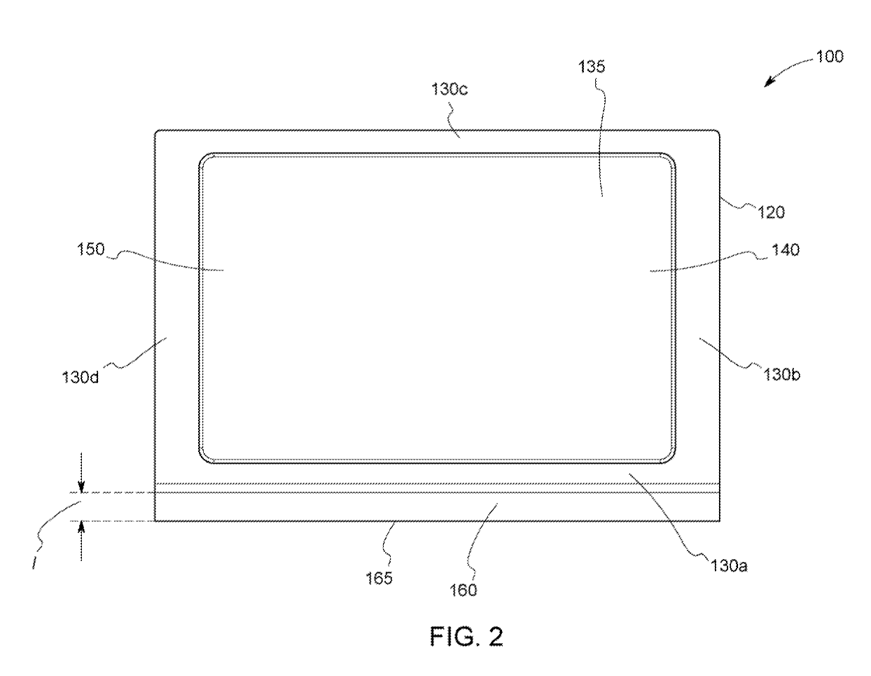

Preferably, the downwardly sloping lip 160 modulates the overall bending moment of the entire shelf 100 by increasing an overall height measured from the outermost end 165 to the top surface 135 of the molded tempered shelf 100. The downwardly sloping lip 160 is stronger than a shelf 100 without the downward sloping lip 160 due to the bending strength. The downward sloping lip 160 varies the shelf 100 thickness, changes the bending moment, and may increase the strength of the shelf 100 by a factor of about three. The sloping lip 160 preferably acts as a reinforcing rib for the shelf 100. Downwardly sloping lip 160 reduces the overall stress and increases the strength of the shelf 100 and reduces the stiffness of the shelf 100. In yet another embodiment of the present disclosure, a rear lip (not shown) can be added to the rear of the shelf 100 to direct air for more efficient refrigerator cooling. Additionally, the glass shelf 100 also can be made to not have the center slumped area 150 shown in FIG. 2 (i.e. non-spill proof). The glass shelf 100 with the lip 160 preferably can be used in fresh food compartment or in a freezer compartment.

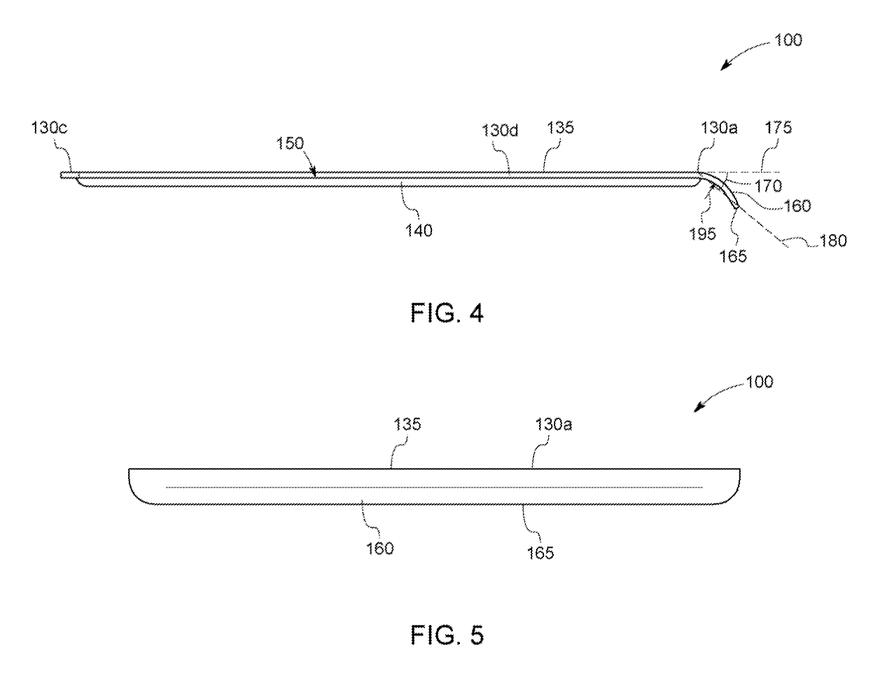

Turning now to FIG. 7, there is shown a number of method steps for manufacturing the shelf according to the present disclosure. FIG. 7 shows a basic rectangular glass sheet 190 that is provided to manufacture the shelf 100 according to the present disclosure. The glass sheet 190 is generally rectangular in shape, but can have different shapes. The glass sheet 190 preferably has a desired height, width and thickness that is suitable for the molding application. As mentioned above, the shelf 100 according to the present disclosure is preferably manufactured from a tempered glass sheet, but can be alternatively be made from different materials and the instant method merely shows one preferred embodiment of the present disclosure.

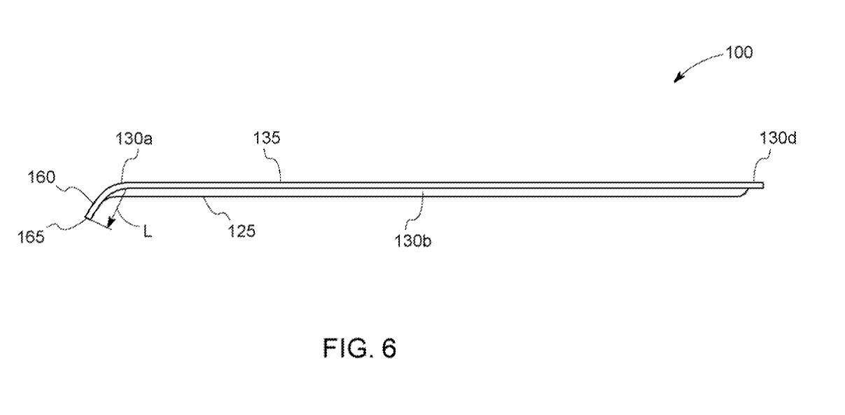

Turning now to FIG. 8, the glass sheet 190 and a mold 200 are placed in a kiln (not shown) to slump the glass sheet 190 to the mold 200. The kiln is a thermally insulated chamber in which a predetermined temperature regime is generated in order to heat the glass rectangular sheet 190 to a transition temperature whereby the rectangular glass sheet 190 can change in shape. As can be seen the mold 200 includes a plurality of features that are complementary to mold the sheet into the desired configuration. The kiln may be powered by natural gas, electricity, propane or any other suitable energy source to raise the temperature to a range that may include a high-temperature of 1280 Celsius degrees. A mold 200 is disposed in the kiln. The pliable raw glass sheet 190 is placed on a rigid object or model called a pattern. The mold 200 shown in a cross sectional view preferably includes a first raised portion 205 and a second raised portion 210 and a containment feature 215 that is recessed between the first and the second raised portions 205 and 210. The first and the second raised portions 205 and 210 preferably correspond to the rear and the front frame portions 130a and 130c of FIGS. 1 and 2, while the containment region 215 generally corresponds to the plate component 140 and the containment region 150 of FIGS. 1 and 2.

The mold 200 further includes a downwardly sloping region 220 that extends from the second raised portion 210. Region 220 slopes downwardly a predetermined distance at a predetermined angle relative to an upper mold surface 225 and has an end that is in a different plane than the containment region 215. The downwardly sloping region 220 of the mold 200 generally corresponds to the downwardly sloping lip 160 of the shelf 100 shown in FIGS. 1 and 2. The glass sheet 190 is brought into contact on a top of the mold 200 and placed in the kiln and heated to slump the glass rectangular sheet 190.

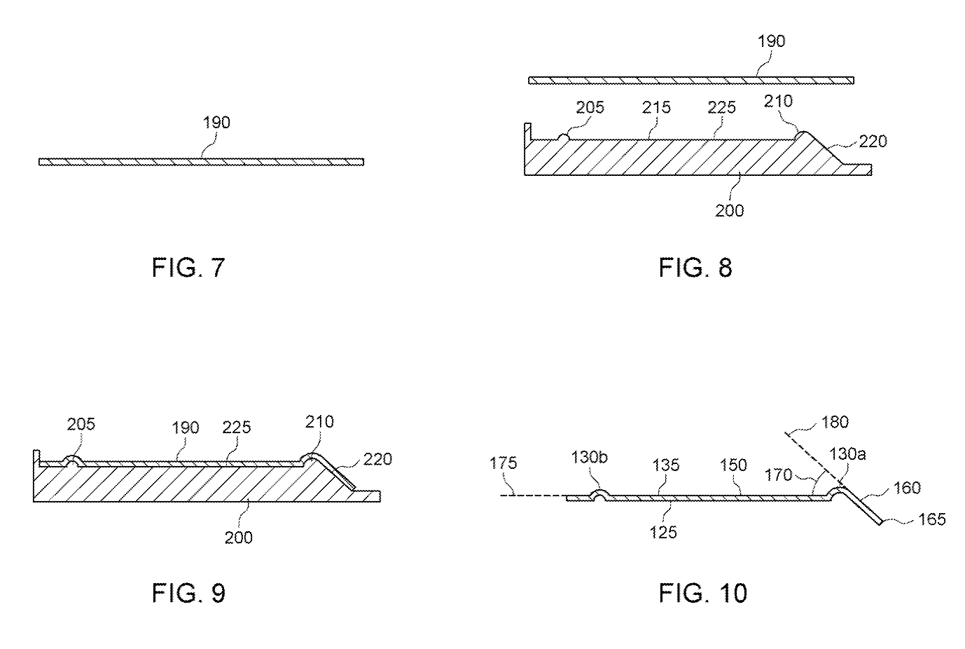

Turning now to FIG. 9, there is shown the glass rectangular sheet 190 heated and slumped over the mold 200 in a cross sectional view. The glass rectangular sheet 190 is preferably heated to slump the glass 190. The glass rectangular sheet 190 is then taken out of the kiln and then rapidly cooled to temper the glass sheet to form the shelf 100. The glass sheet 100, in one non-limiting embodiment, is placed onto the mold 200 and heated above an annealing point of about 720° C. Preferably, the glass sheet 100, in one embodiment, is brought slightly above the transition temperature so the sides of the glass shelf 100 curve or become rounded and polished, thus eliminating a post operation rounding step. One drawback is that care must be taken that the glass material 190 does not burn and yellow if brought to a temperature that is too hot.

The shelf 100 is then rapidly cooled with forced air drafts while the inner portion remains free to flow for a short time. The greater contraction of an inner layer of the shelf 100 during manufacturing induces compressive stresses in the surface of the shelf 100 balanced by tensile stresses in the body of the shelf 100. The compressive stress on the surface of the shelf 100, in one embodiment, can be in a range that includes about 69 MPa. In yet another embodiment, the surface compressive stress of the shelf 100 can exceed 100 MPa. There are two methods to temper glass, by a heat treatment or by a chemical treatment. Generally, a chemical treatment will cause sharps edges if the shelf 100 breaks, and is not favored unless the glass is sufficient thick and designed to never break under the load.

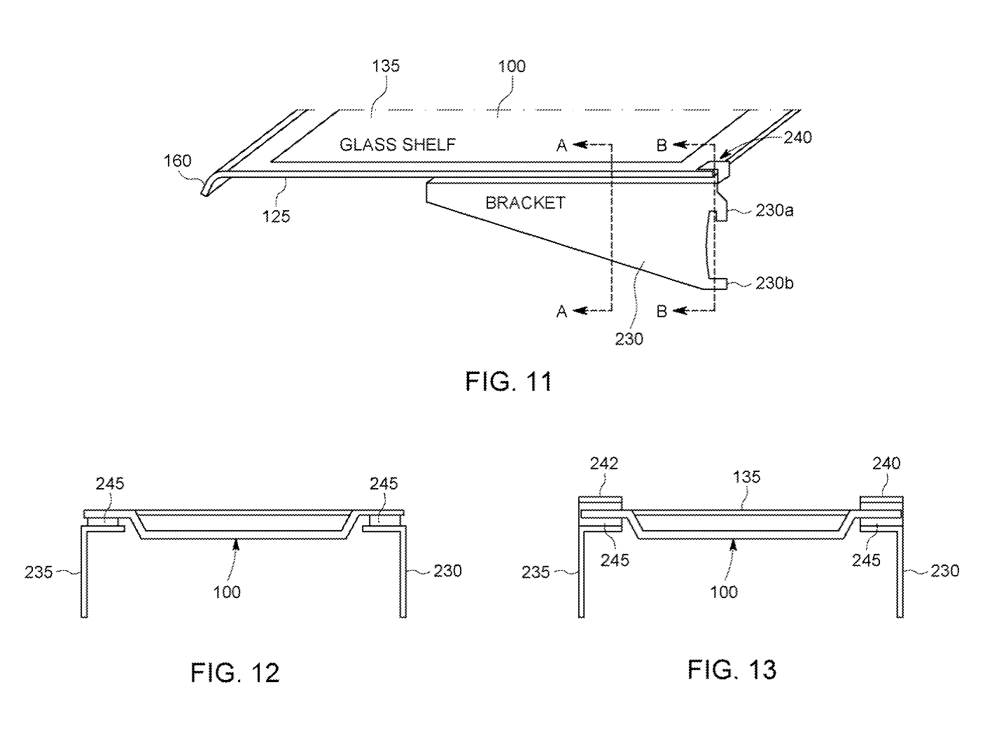

Turning now to FIG. 10, which shows the completed slumped and tempered glass sheet forming the shelf 100, the shelf 100 includes an end or edge 165, a downwardly sloping lip 160, a front frame portion 130a, a rear frame portion 130b, a containment region 150, a top surface 135 and a bottom surface 125. Preferably, the end 165 is in a different plane than a main plane formed by the containment region 150. End 165 also extends about an inch in length from the top surface 135 and at an angle 170 that is about forty five degrees, but can be in a range that includes ninety degrees or more to thirty degrees or less. The downwardly sloping lip 160 preferably forms a strengthening rib for the shelf 100 and may also act as a handle to grip the shelf 100. It should be appreciated that a portion of the shelf's 100 the rear opposite the lip 160 is trimmed and cut down for aesthetic purposes to fit into the refrigerator (not shown).

FIGS. 11-13 and 19 show the shelf 100 including a first and a second bracket 230, 235. There is shown the glass shelf 100 having a top side 135 and a bottom side 125 with a first bracket 230 adhered to the bottom side 125 of the glass shelf 100. Bracket 230 is connected to the glass shelf 100 by at least two different locations for a stable configuration. The rear of the bracket 230 further includes a bracket lip 240. The bracket lip 240 engages a shelf 100 from the rear (or side) and is manufactured to a clip the top and bottom surfaces 135, 125 of the shelf 100. Bracket lip 240 provides for a secondary attachment between the bracket 230 and the shelf 100 (the first attachment being the adhesive layer 245 shown in FIG. 12). The terms primary and secondary form no limitations to the present disclosure and bracket lip 240 may be the primary attachment while the adhesive layer 245 may be the secondary attachment. Bracket lip 240 safeguards against adhesive separation.

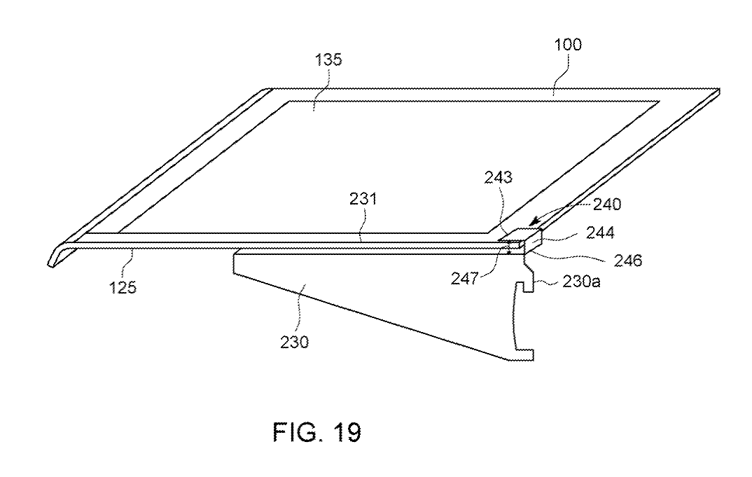

Turning now to FIG. 19, there is shown an enlarged view of the bracket lip 240 of FIG. 11. Bracket lip 240 is a generally orthogonally shaped two part clip member 243, 244 that is integrally connected to a rear top side 246 of the bracket 230. Clip member 244 is generally perpendicular to clip member 243 so a sheet 100 can be inserted and gripped by clip member 243 and the top side 231 of the bracket 230. Alternatively, the clip member 243, 244 can be a one part curved member. The orthogonally shaped clip member comprises a first clip member 244 that extends from the rear top side 246 of the first bracket 230 and a second clip member 243 that is connected to the first clip member 244. The clip members 243, 244 together form a generally “C” shaped member with the bottom side 231 of the bracket 230. Bracket lip 240 has a cantilevered second clip member 243 that is generally parallel to a top surface 231 of the first bracket 230. The bracket lip 240 forms an interior space 247 between a top side 231 of the first bracket 230 and the second clip member 243. The interior space 247 is sized so the shelf 100 can fit and be gripped therein and may have various dimensions. In one embodiment, the interior space 247 is sufficient to securely hold a 4 millimeter thick shelf 100.

Turning now again to FIG. 11, advantageously, the bracket 230 with the bracket lip 240 does not rely on adhesive as the sole means of attachment. When a 501b load is applied to the front lip 160 of the shelf 100 (representing a small child stepping on the front lip 160) a moment is applied to the glass shelf 100 putting the adhesive 245 in tension. This moment could potentially cause a separation in some instances. The bracket lip 240 also provides that the glass shelf 100 will not rotate once secured in the interior space 247. Turning to FIG. 12, there is shown a cross sectional view of the shelf 100 along line A-A of FIG. 11. The brackets 230 and 235 are shown connected to the glass shelf 100 by an adhesive layer 245.

Turning now to FIG. 13, there is shown a cross sectional view of the shelf 100 along line B-B of FIG. 11. The brackets 230 and 235 are shown connected to the glass shelf 100 by the adhesive layer 245. A first bracket lip 240 and a second bracket lip 242 are provided. The bracket lips 240 and 242 secure the end or alternatively the lateral sides of the glass shelf 100. Bracket lips 240 and 242 secure the top side 135 of the glass shelf 100 between the lip 240 and 242 and a top 231 (FIG. 19) of the respective bracket 230 and 235. Bracket lips 240 and 242 also secure and clip the glass shelf 100 in place and prevent rotation of the glass shelf 100. Therefore, the brackets 230, 235 do not rely on the adhesive layer 245 as the sole method of attachment, and instead are attached by at least two points per bracket 230, 235. The brackets 230, 235 can be sheet-metal (or casted or molded) and the bracket lips 240, 242 catch the back edge or side edge of the glass shelf 100. When a load is applied to the front lip 160 of the glass shelf 100, the bracket lips 240, 242 provide a reaction force preventing glass shelf 100, the bracket 230, 235 and the adhesive bond 245 from separating. Bracket lips 240, 242 can be parallel with the back edge or parallel with the side edge of the glass shelf 100 and are not limited to the shown location.

Preferably, the adhesive layer 245 is applied to the brackets 230, 235 and then the glass shelf 100 is placed on the brackets 230, 235 and then the adhesive layer 245 is cured. In another alternative embodiment, for slide-out shelves using a refrigerator with cant tracks to hold the shelf 100 in place, brackets 230, 235 would be attached to either side of the shelf 100. This assembly would then mount to a secondary bracket structure (not shown) so the assembly 100 moves in a sliding relationship. The secondary bracket structure would mount to the cant track. In yet another embodiment, the refrigerator includes a liner support and half size shelves 100 are used. The shelf assembly 100 would thus use a combination of a liner support on one side and a bracket attached to a cant track on the other side. Accordingly, in this embodiment, the glass shelf 100 can be supported with one bracket 235 or 230 and the number of brackets 230, 235 can be less than two.

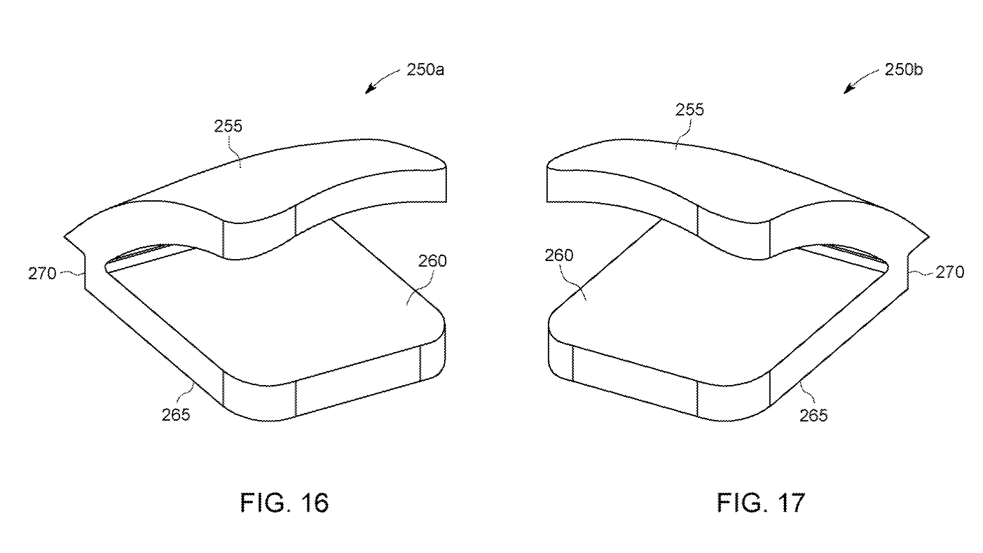

FIGS. 14-15 show two perspective views of the glass shelf 100 having the left frame portion 130d with a first stop member 250a applied to the left frame portion 130d. A second stop member 250b can be attached to the right frame portion 130b. The first stop member 250a and the second stop member 250b preferably act to prevent the shelf 100 from being fully removed from a refrigeration cabinet. This removal may potential cause injury to the consumer when sliding the glass shelf 100 out of the cabinet.

Turning now to FIGS. 16-17, the first stop member 250a and the second stop member 250b are shown as a two part member 255, 260. Members 255, 260 are connected at side 270. Stop members 250a, 250b also include a bottom side 265, that connects to the left frame portion 130d and a right frame portion 130b of the glass shelf 100 to protect the shelf 100. Open side of the stop members 250a, 250b catch to prevent the shelf 100 from being fully removed. It is understood that a stop feature could be integrally molded into the edge of the glass 100 during the slump process. Various stop configurations are possible and within the scope of the present disclosure.

FIG. 18 shows the completed glass shelf 100 mounted in a number of channels 280a, 280b, and 280c disposed in an opened refrigeration cabinet 275. As can be seen, the translucent configuration of the tempered glass shelf 100 provides for a thin, yet strong, and appealing configuration in the cabinet 275.

Thus, while there have shown and described and pointed out fundamental novel features of the disclosure as applied to various specific embodiments thereof, it will be understood that various omissions and substitutions and changes in the form and details of the apparatus illustrated, and in their operation, may be made by those skilled in the art without departing from the spirit of the disclosure. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A shelf assembly comprising:
a sheet defining a main plane, the sheet comprising a plurality of raised surfaces that extend from a top surface to define a spill proof area on the top surface, at least one of the plurality of raised surfaces having an end, the sheet further comprising a lip extending outward from the end of the at least one of the plurality of raised surfaces, the lip having a front edge and extending outward from the end with the front edge being in a plane different from the main plane.

2. The shelf assembly of claim 1, further comprising a bracket comprising a body with a top side and a bracket lip, the bracket lip having a clip member and an interior space defined between the clip member and the top side of the body, the sheet positioned between the clip member and the top side of the body in the interior space.

3. The shelf assembly of claim 2, wherein the body is disposed under the sheet to support the sheet.

4. The shelf assembly of claim 3, wherein the top side of the body is adhered to a bottom surface of the sheet.

5. The shelf assembly of claim 3, further comprising a second bracket having a second body with a second top side, the second top side supporting the sheet with the second body disposed under the sheet.

6. The shelf assembly of claim 5, wherein the second top side of the second body is adhered to a bottom surface of the sheet.

7. The shelf assembly of claim 2, wherein the sheet has a rear side opposite the lip, wherein the rear side of the sheet is positioned in the interior space.

8. The shelf assembly of claim 2, wherein the sheet has a lateral side substantially perpendicular to the lip, wherein the lateral side of the sheet is positioned in the interior space.

9. The shelf assembly of claim 1, wherein the lip traverses at a downward angle from the sheet and the front edge terminates at a predetermined distance below a bottom surface of the sheet.

10. The shelf assembly of claim 1, wherein the lip traverses at an upward angle from the sheet and the front edge terminates at a predetermined distance above the top surface of the sheet.

11. The shelf assembly of claim 1, wherein the lip traverses at a downward angle of about forty five degrees from the main plane of the sheet.

12. The shelf assembly of claim 1, wherein the lip is integrally connected to the end of a front raised surface to form a unitary member with the front raised surface.

13. The shelf assembly of claim 1, wherein the sheet is tempered glass.

14. The shelf assembly of claim 1, wherein the lip forms a handle to grip the shelf assembly, and wherein the sheet has a thickness of about 4 millimeters.

15. The shelf assembly of claim 1, wherein the lip changes a bending moment of the sheet to strengthen the sheet.

16. The shelf assembly of claim 1, wherein the sheet, the plurality of raised surfaces and the lip are formed as one integral member, and wherein the spill proof area holds a volume of about twelve ounces.

17. A method of manufacturing a shelf, comprising:
providing a moldable material;
providing a mold with a first mold surface defining a main plane with a plurality of raised surfaces that extend from the first mold surface to define a spill proof area on the first mold surface, the mold having a second mold surface connected to at least one of the plurality of raised surfaces of the first mold surface, the second mold surface extending outward from at least one of the plurality of raised surfaces of the first mold surface, the second mold surface having an end being in a plane different from the main plane;
placing the moldable material on the mold and placing the mold in a kiln;
heating the moldable material to below or about a transition temperature to shape the moldable material to the mold;
removing the moldable material and the mold from the kiln;
cooling the moldable material to form the shelf; and
separating the shelf from the mold.

18. The method of claim 17, further comprising supporting the shelf on a first bracket comprising a body having a top side and a bracket lip, the bracket lip having a clip member and an interior space defined between the clip member and the top side of the body and supporting the shelf in the interior space of the bracket lip between the clip member and the top side of the body.

19. The method of claim 18, further comprising adhering the first bracket to the shelf, and supporting the shelf on a second bracket comprising a second body having a second top side and a second bracket lip, the second bracket lip having a second clip member and a second interior space defined between the second clip member and the second top side of the second body, and placing the shelf in the second interior space, and providing glass as the moldable material, tempering the glass and adhering the second bracket to the shelf.

20. A refrigerator comprising:
a storing compartment; and
a shelf disposed in the storing compartment, the shelf comprising:
a tempered glass sheet defining a main plane with a plurality of raised surfaces extending upward from the main plane to define a spill proof area on the tempered glass sheet, at least one of the plurality of raised surfaces having an end, the tempered glass sheet further comprising a lip, the lip having a front edge and extending outward from the end with the front edge being in a plane different from the main plane,
wherein the tempered glass sheet, the plurality of raised surfaces and the lip form a unitary member.
